(19) United States
(12) Patent Application Publication
(10) Pub. No.: US 2024/0253690 A1
(43) Pub. Date: Aug. 1, 2024

(54) COMPONENT FOR VEHICLE INTERIOR

(71) Applicant: Shanghai Yanfeng Jinqiao Automotive Trim Systems Co. Ltd., Novi, MI (US)

(72) Inventors: Peter Thielhorn, Muelheim/Ruhr (DE); Holger Maul, Groß-Zimmern (DE); Heinz Gielen, Viersen (DE); Daniel Grosch, Pulheim (DE); Lucas Steffens, Cologne (DE)

(21) Appl. No.: 18/632,618

(22) Filed: Apr. 11, 2024

Related U.S. Application Data
(63) Continuation of application No. PCT/US22/46626, filed on Oct. 13, 2022.
(60) Provisional application No. 63/262,513, filed on Oct. 14, 2021.

(51) Int. Cl. B62D 1/06

(52) U.S. Cl. CPC B62D 1/06

(57) ABSTRACT

A component for a vehicle interior may comprise a steering wheel comprising a frame and a composite structure comprising a set of segments. The set of segments may comprise a set of shell segments assembled in axial alignment on the frame and/or in radial engagement around the frame. The set of shell sections may comprise a shell section fit onto the frame; the set of shell sections may be configured for snap-fit assembly. The frame may comprise a feature/indentation facilitating axial alignment and/or radial engagement of a shell section on the frame. A shell section may comprise an engagement portion and/or positioning element. The set of shell sections may comprise a first section fit onto the frame and a second section fit with the first section. The steering wheel may comprise a modular design configured for efficient assembly and/or mass reduction.

### CROSS-REFERENCE TO RELATED APPLICATIONS

The present application is a continuation of PCT/International Patent Application No. PCT/US2022/046626 titled “COMPONENT FOR VEHICLE INTERIOR” filed Oct. 13, 2022, which claims the benefit of U.S. Provisional Patent Application No. 63/262,513 titled “VEHICLE INTERIOR COMPONENT” filed Oct. 14, 2021.

The present application claims priority to and incorporates by reference in full the following patent applications: (1) U.S. Provisional Patent Application No. 63/262,513 titled “VEHICLE INTERIOR COMPONENT” filed Oct. 14, 2021; (2) PCT/International Patent Application No. PCT/US2022/046626 titled “COMPONENT FOR VEHICLE INTERIOR” filed Oct. 13, 2022.

The present application is related to and incorporates by reference in full the following patent applications: (1) PCT/International Patent Application No. PCT/US2022/46625 titled “COMPONENT FOR VEHICLE INTERIOR” filed Oct. 13, 2022; (2) U.S. patent application Ser. No. ______ (Docket No. FIP 21074-UT-US-04) titled “COMPONENT FOR VEHICLE INTERIOR” filed April ______, 2024.

### FIELD

The present invention relates to a component for a vehicle interior.

The present invention also relates to a component such as a steering wheel for a vehicle interior.

### BACKGROUND

It is known to provide a component for a vehicle interior such as a steering wheel a base and a rim with a frame.

It would be advantageous to provide for a component for a vehicle interior such as a steering wheel that is configured with a rim comprising a composite structure.

It would be advantageous to provide for a component for a vehicle interior such as a steering wheel that is configured with a rim comprising a composite structure comprising at least one segment.

It would be advantageous to provide for a component for a vehicle interior such as a steering wheel that is configured with a rim comprising a composite structure comprising at least one segment that is configured for efficient assembly.

It would be advantageous to provide for a component for a vehicle interior such as a steering wheel that is configured with a rim comprising a composite structure comprising at least one segment that comprises sections configured for efficient assembly.

It would be advantageous to provide for a component for a vehicle interior such as a steering wheel that is configured with a rim comprising a composite structure comprising at least one segment that comprises sections configured to engage for efficient assembly onto the frame of the rim.

It would be advantageous to provide for a component for a vehicle interior such as a steering wheel that is configured with a rim comprising a composite structure comprising at least one segment that comprises a set of segments configured for efficient assembly.

It would be advantageous to provide for a component for a vehicle interior such as a steering wheel that is configured with a rim comprising a composite structure comprising at least one segment comprising a functional layer in the form of a heating element or hands-off display sensor.

### SUMMARY

The present invention relates to a component for a vehicle interior comprising a steering wheel comprising a frame; and a composite structure comprising a set of segments. The set of segments may comprise a set of shell segments configured to be assembled in axial alignment on the frame. The set of shell segments may comprise a set of shell sections configured to be fit in radial engagement around the frame. The set of shell sections may comprise a shell section configured to be fit onto the frame. The frame may comprise a feature configured to facilitate axial alignment of a shell section of the set of shell sections on the frame. The frame may comprise a feature configured to facilitate radial engagement of a shell section of the set of shell sections on the frame. The feature of the frame may comprise an indentation. The set of shell sections may comprise a front section and a back section. The set of shell sections may comprise a first section configured to be fit onto the frame and a second section configured to be fit with the first section. The set of shell sections may comprise a first section comprising an engagement portion configured to be fit with the frame and a second section comprising an engagement portion configured to be fit with the first section. The set of shell sections may comprise a first section comprising an engagement portion configured to be fit with the frame and a second section comprising an engagement portion configured to be snap-fit with the first section. The set of segments may comprise at least one of a decorative segment and/or a functional segment. The steering wheel may comprise a rim; the rim may comprise a cover configured to provide an exterior surface and an intermediate layer under the cover; the intermediate layer may comprise at least one of a shell section and/or a soft material and/or a resilient material.

The present invention relates to a steering wheel providing a frame comprising a composite structure. The composite structure may comprise a set of segments configured to be assembled onto the frame. The set of segments may comprise at least one shell segment configured for radial engagement and axial alignment on the frame. The at least one shell segment may comprise a set of shell segments. The composite structure may be configured to provide a visual effect. When the set of shell segments is assembled onto the frame an engagement portion of a first shell segment can be connected at an engagement portion of a second shell segment. When the set of shell segments is assembled onto the frame an engagement portion of a shell segment can be connected at a feature of the frame. The feature of the frame may comprise an indentation on the frame configured to facilitate axial alignment of a shell segment. The set of shell segments may comprise a set of shell sections configured to fit together in radial engagement. The set of shell segments may comprise a first segment and a second segment; the first segment may be different than the second segment. The at least one shell segment may comprise a positioning element. The composite structure may comprise a cover comprising a cover layer; the cover layer may comprise a decorative layer and/or a functional layer; the cover layer may be configured to provide a visual effect and/or a tactile effect. The at least one shell segment may comprise a set of shell segments configured to provide the visual effect; the visual effect may comprise a multi-segment appearance.

The present invention relates to a component for a vehicle interior comprising a steering wheel comprising a frame and a composite structure comprising a set of segments. The set of segments may comprise a set of shell segments assembled in axial alignment on the frame and/or in radial engagement around the frame. The set of shell sections may comprise a shell section fit onto the frame; the set of shell sections may be configured for snap-fit assembly. The frame may comprise a feature facilitating axial alignment and/or radial engagement of a shell section on the frame; the feature may comprise an indentation. A shell section may comprise an engagement portion and/or positioning element. The set of shell sections may comprise a first section fit onto the frame and a second section fit with the first section; the set of shell sections may comprise a front section and a back section. The set of segments of the composite structure may be configured to provide a visual effect. The steering wheel may comprise a modular design configured for efficient assembly and/or mass reduction.

The present invention relates to a component for a vehicle interior comprising a steering wheel comprising a frame; and a composite structure comprising a set of segments. The set of segments may comprise a set of shell segments configured to be assembled in axial alignment on the frame. The set of shell segments may comprise a set of shell sections configured to be fit in radial engagement around the frame. The set of shell sections may comprise a shell section configured to be fit onto the frame. The set of shell sections may comprise a shell section configured to be snap-fit onto the frame. The set of shell sections may comprise a shell section comprising an engagement portion configured to be fit onto the frame. The frame may comprise a feature configured to facilitate axial alignment of a shell section of the set of shell sections on the frame. The feature of the frame may comprise an indentation. The steering wheel may comprise a multi-segment construction comprising the set of segments. The frame may comprise a feature configured to facilitate radial engagement of a shell section of the set of shell sections on the frame. The feature of the frame may comprise an indentation. The set of shell sections may comprise a front section and a back section. The set of shell sections may comprise a first section configured to be fit onto the frame and a second section. The set of shell sections may comprise a first section configured to be fit onto the frame and a second section configured to be fit with the first section. The set of shell sections may comprise a first section comprising an engagement portion configured to be fit with the frame and a second section comprising an engagement portion configured to be fit with the first section. The set of shell sections may comprise a first section comprising an engagement portion configured to be fit onto the frame and a second section comprising an engagement portion configured to be fit into the first section. The set of shell sections may comprise a first section and a second section configured to be fit with the first section. The set of shell sections may comprise a first section configured to be fit with the frame and a second section comprising an engagement portion configured to be fit with the first section. The set of shell sections may comprise a first section configured to be fit with the frame and a second section comprising an engagement portion configured to be snap-fit with the first section. The set of shell sections may comprise a front section configured to be fit onto the frame and a back section configured to be fit with the front section. The set of segments may comprise at least one of a decorative segment and/or a functional segment. The composite structure may comprise a cover comprising a cover layer; the cover layer may comprise an exterior surface for the steering wheel. The composite structure may comprise the cover layer and an intermediate layer under the cover layer. The frame and the composite structure may comprise a rim for the steering wheel. The composite structure may comprise a rim; the rim may comprise the set of segments comprising a decorative segment and a functional segment. The steering wheel may comprise a rim; the rim may comprise a cover configured to provide an exterior surface and an intermediate layer under the cover; the intermediate layer may comprise at least one of a shell section and/or a soft material and/or a resilient material. The composite structure may comprise the cover and the intermediate layer. The cover may comprise a cover layer. The composite structure may comprise the cover layer and the intermediate layer under the cover layer. The rim may comprise the frame and the composite structure. The composite structure may comprise the frame. The frame may comprise an armature. The set of shell sections may comprise a front section and a back section configured to be fit together onto the frame in radial engagement and axial alignment. The set of shell sections may comprise a front section and a rear section configured to be fit together onto the frame in radial engagement and axial alignment.

The present invention relates to a steering wheel providing a frame comprising a composite structure. The composite structure may comprise a set of segments configured to be assembled onto the frame. The set of segments may comprise at least one shell segment configured in radial engagement and axial alignment on the frame. The composite structure may be configured to provide a visual effect comprising a multi-segment appearance. The at least one shell segment may comprise a set of shell segments. When the set of shell segments is assembled onto the frame an engagement portion of a shell segment can be connected onto the frame. When the set of shell segments is assembled onto the frame an engagement portion of a first shell segment can be connected at an engagement portion of a second shell segment. When the set of shell segments is assembled onto the frame the engagement portion of a first shell segment can be snap-fit connected at the engagement portion of a second shell segment. When the set of shell segments is assembled onto the frame an engagement portion of a shell segment can be connected at a feature of the frame. The feature of the frame may comprise an indentation on the frame. The feature of the frame may comprise an indentation on the frame configured to facilitate axial alignment of a shell segment. The set of shell segments may comprise a set of shell sections configured to fit in radial engagement. The set of shell segments may comprise a set of shell sections configured to snap-fit in radial engagement. The set of shell segments may comprise a set of shell sections configured to fit together in radial engagement. The at least one shell segment may comprise an engagement portion. The set of shell segments may comprise a set of selectable shell segments configured to be assembled onto the frame of the rim. The rim may comprise a multi-segment construction comprising the set of shell segments. The set of shell segments may comprise a first segment and a second segment; a cover layer on the first segment may be different than a cover layer on the second segment. The set of shell segments may comprise a first segment and a second segment; the first segment may be different than the second segment. Each segment of the set of shell segments may comprise a shell segment base. Each shell segment of the set of shell segments may comprise an engagement portion. When the set of shell segments is assembled onto the frame the engagement portion of a first shell segment can be connected at the engagement portion of a second shell segment. When the set of shell segments is assembled onto the frame the engagement portion of a first shell segment can be snap-fit connected at the engagement portion of a second shell segment. When the set of shell segments is assembled onto the frame the engagement portion of a first shell segment can be connected at the engagement portion of a second shell segment in axial alignment. The engagement portion may comprise a connector and/or a plurality of connectors. The connector may comprise a snap-fit connector. The connector may comprise a snap-fit connector comprising a projection and a receptacle for the projection. The engagement portion may comprise at least one of a projection or a receptacle for the projection. The rim may comprise a multi-segment construction comprising a set of selectable shell segments. The at least one shell segment may comprise a first shell section and a second shell section. When the set of shell segments is assembled onto the frame the first shell section may be attached to the second shell section. When the set of shell segments is assembled onto the frame the first shell section may be attached to the second shell section in radial alignment. The first shell section may comprise a first engagement portion; the second shell section may comprise a second engagement portion configured to engage the first engagement portion of the first shell section. The composite structure may comprise a positioning element. The at least one shell segment may comprise a positioning element. The composite structure may comprise a cover comprising a cover layer; the cover layer may comprise a decorative layer. The cover layer may be configured to provide a visual effect for the rim and/or a tactile effect for the rim. The cover layer may comprise at least one of a fabric material, a textile material, a fiber material, a leather, a synthetic leather material, a foil, a skin, a wrap, a veneer, a recycled material. The visual effect may comprise a multi-segment appearance. The visual effect may comprise a multi-section appearance. The visual effect may comprise a multi-tone appearance. The visual effect may comprise a modular appearance. The frame may comprise an armature. The intermediate layer may comprise at least one of a foam material or a spacer material. The intermediate layer may comprise a carrier layer on the frame. The intermediate layer may comprise a carrier layer on the frame and at least one of soft material or a resilient material or a foam material or a spacer material.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The composite structure may be configured to provide a visual effect for the rim. The at least one shell segment may comprise a set of shell segments. The visual effect may comprise a multi-segment appearance provided by the set of shell segments. The composite structure of the rim may comprise at least one shell segment comprising a cover layer and an intermediate layer under the cover layer. The cover layer may be configured to provide the visual effect for the rim. The cover layer may comprise at least one of a fabric material, a textile material, a fiber material, a leather, a synthetic leather material, a foil, a skin, a wrap, a veneer, a recycled material. The intermediate layer may comprise a carrier layer on the frame. The set of shell segments may comprise a first segment and a second segment; the first segment may be different than the second segment. The set of shell segments may be assembled onto the frame in axial alignment. The set of shell segments may be assembled onto the frame in axial alignment at an engagement portion. The engagement portion may comprise a connector for each shell segment of the set of shell segments. The connector may comprise a snap-fit connector comprising a projection and a receptacle for the projection. The at least one shell segment may comprise a first shell section and a second shell section. The set of shell segments may be assembled onto the frame; the first shell section may be attached to the second shell section in radial alignment. The first shell section may comprise a first engagement portion; the second shell section may comprise a second engagement portion configured to engage the first engagement portion of the first shell section. The composite structure may comprise a positioning element. The at least one shell segment may comprise a positioning element. The positioning element may be configured to facilitate connectivity for the functional layer. The set of segments may comprise a set of shell sections; the set of shell sections may comprise a front section and a back section. The composite structure may comprise a rim. The composite structure may comprise the frame. The composite structure may comprise a positioning layer. The set of segments may comprise a decorative segment and the functional segment; the decorative segment may comprise the cover. The composite structure may comprise an intermediate layer under the cover. The composite structure may comprise a rim; the composite structure may comprise a cover configured to provide an exterior surface for the rim and an intermediate layer under the cover layer; the intermediate layer may comprise at least one of a shell section and/or a soft material and/or a resilient material. The steering wheel may comprise a rim; the rim may comprise a cover configured to provide an exterior surface and an intermediate layer under the cover; the intermediate layer may comprise at least one of a shell section and/or a soft material and/or a resilient material. The composite structure may comprise the cover and the intermediate layer. The cover may comprise a cover layer. The composite structure may comprise the cover layer and the intermediate layer under the cover layer. The rim may comprise the frame and the composite structure. The composite structure may comprise the frame. The frame may comprise an armature.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The cover layer may comprise an exterior surface for the rim. The intermediate layer may comprise at least one of a soft material or a resilient material. The intermediate layer may comprise at least one of a foam material or a spacer material. The intermediate layer may comprise a carrier layer on the frame. The intermediate layer may comprise a carrier layer on the frame and at least one of soft material or a resilient material or a foam material or a spacer material. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The rim may comprise a multi-segment construction comprising a set of selectable shell segments. The set of shell segments may comprise a first segment and a second segment; the cover layer on the first segment may be different than the cover layer on the second segment. The set of shell segments may comprise a first segment and a second segment; the first segment may be different than the second segment. Each segment of the set of shell segments may comprise a shell segment base. Each shell segment of the set of shell segments may comprise an engagement portion. When the set of shell segments is assembled onto the frame the engagement portion of a first shell segment may be connected at the engagement portion of a second shell segment. When the set of shell segments is assembled onto the frame the engagement portion of a first shell segment may be snap-fit connected at the engagement portion of a second shell segment. When the set of shell segments is assembled onto the frame the engagement portion of a first shell segment may be connected at the engagement portion of a second shell segment in axial alignment. The engagement portion may comprise a connector and/or a plurality of connectors. The connector may comprise a snap-fit connector. The connector may comprise a snap-fit connector comprising a projection and a receptacle for the projection. The engagement portion may comprise at least one of a projection or a receptacle for the projection. The at least one shell segment may comprise a first shell section and a second shell section. When the set of shell segments is assembled onto the frame the first shell section may be attached to the second shell section. When the set of shell segments is assembled onto the frame the first shell section may be attached to the second shell section in radial alignment. The at least one shell segment may comprise a first shell section and a second shell section. The first shell section may comprise a first engagement portion; the second shell section may comprise a second engagement portion configured to engage the first engagement portion of the first shell section. The cover layer may comprise a decorative layer. The composite structure may comprise a positioning element. The at least one shell segment may comprise a positioning element. The cover layer may be configured to provide a visual effect for the rim and/or a tactile effect for the rim. The cover layer may comprise at least one of a fabric material, a textile material, a fiber material, a leather, a synthetic leather material, a foil, a skin, a wrap, a veneer, a recycled material. The composite structure may be configured to provide a visual effect for the rim. The visual effect may comprise a multi-segment appearance. The visual effect may comprise a multi-section appearance. The visual effect may comprise a multi-tone appearance. The visual effect may comprise a modular appearance. The at least one segment may comprise a first segment and a second segment; the cover layer of the first segment may be different from the cover layer of the second segment. The steering wheel may comprise a spoke structure connecting the rim to the base. The steering wheel may comprise a functional layer; the functional layer may comprise at least one of a (a) sensor for hands-off detection or (b) heating mat. The base may comprise an airbag module. The frame may comprise an armature. The base may comprise a cover; the cover may provide a logo.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The composite structure may be configured to provide a visual effect for the rim. The at least one shell segment may comprise a set of shell segments. The visual effect may comprise a multi-segment appearance provided by the set of shell segments. The visual effect may comprise a multi-segment appearance. The visual effect may comprise a multi-section appearance. The visual effect may comprise a multi-tone appearance. The cover layer may be configured to provide the visual effect for the rim. The cover layer may comprise at least one of a fabric material, a textile material, a fiber material, a leather, a synthetic leather material, a foil, a skin, a wrap, a veneer, a recycled material. The intermediate layer may comprise at least one of a foam material or a spacer material. The intermediate layer may comprise a carrier layer on the frame. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The set of shell segments may comprise a first segment and a second segment; the cover layer on the first segment may be different than the cover layer on the second segment. The set of shell segments may comprise a first segment and a second segment; the first segment may be different than the second segment. The set of shell segments may be assembled onto the frame in axial alignment. The set of shell segments may be assembled onto the frame in axial alignment at an engagement portion. The engagement portion may comprise a connector for each shell segment of the set of shell segments. The connector may comprise a snap-fit connector comprising a projection and a receptacle for the projection. The at least one shell segment may comprise a first shell section and a second shell section. The set of shell segments may be assembled onto the frame; the first shell section may be attached to the second shell section in radial alignment. The first shell section may comprise a first engagement portion; the second shell section may comprise a second engagement portion configured to engage the first engagement portion of the first shell section.

The present invention relates to a steering wheel of a type providing a base and a frame comprising a rim comprising a composite structure connected to the base. The composite structure of the rim may comprise at least one shell segment comprising a cover layer and an intermediate layer under the cover layer. The composite structure may comprise a functional layer. The functional layer may comprise at least one of (a) a hands-off sensor or (b) a heating element. The at least one shell segment may be configured for integration of the functional layer. The at least one shell segment may be configured for interconnection of the functional layer. The composite structure may comprise a connector for the functional layer. The base may comprise a control module for the functional layer. The composite structure may comprise a positioning element. The at least one shell segment may comprise a positioning element. The positioning element may be configured to facilitate connectivity for the functional layer. The base may comprise an airbag module. The frame may comprise an armature. The base may comprise a horn module.

### FIGURES

FIG. 1A is a schematic perspective views of a vehicle according to an exemplary embodiment.

FIG. 1B is a schematic perspective views of a vehicle interior according to an exemplary embodiment.

FIGS. 2A and 2B are schematic perspective views of a component shown as a steering wheel with rim according to an exemplary embodiment.

FIGS. 3A through 3J are schematic diagrams of a component shown as a steering wheel according to an exemplary embodiment.

FIG. 4 is a schematic diagram of a component shown as a steering wheel according to an exemplary embodiment.

FIG. 5 is a schematic diagram of a component shown as a steering wheel according to an exemplary embodiment.

FIGS. 6A and 6B are schematic perspective views of a component shown as a steering wheel with rim according to an exemplary embodiment.

FIG. 7 is a schematic exploded perspective view of a component shown as a steering wheel with rim according to an exemplary embodiment.

FIG. 8A is a schematic perspective view of a component shown as a steering wheel with rim according to an exemplary embodiment.

FIG. 8B is a schematic exploded perspective view of a component shown as a steering wheel with rim according to an exemplary embodiment.

FIGS. 9A through 9C are schematic fragmentary perspective views of a component shown as a steering wheel with rim according to an exemplary embodiment.

FIGS. 10A through 10C are schematic fragmentary perspective views of a component shown as a steering wheel with rim according to an exemplary embodiment.

FIG. 11A is a schematic diagram of a component shown as a steering wheel according to an exemplary embodiment.

FIGS. 11B through 11D are schematic cross-section views of a rim of a steering wheel according to an exemplary embodiment.

FIGS. 12A and 12D are schematic cross-section views of a rim of a steering wheel according to an exemplary embodiment.

FIGS. 12B and 12E are schematic fragmentary perspective views of a rim of a steering wheel according to an exemplary embodiment.

FIG. 12C is a schematic perspective view of an element of a rim of a steering wheel according to an exemplary embodiment.

FIG. 13A is a schematic exploded perspective view of a composite structure of a rim of a steering wheel according to an exemplary embodiment.

FIG. 13B is a schematic exploded cross-section view of a composite structure of a rim of a steering wheel according to an exemplary embodiment.

FIG. 13C is a schematic exploded partial cross-section view of a composite structure of a rim of a steering wheel according to an exemplary embodiment.

FIG. 13D is a schematic cross-section view of a composite structure of a rim of a steering wheel according to an exemplary embodiment.

FIG. 14A is a schematic exploded perspective view of a composite structure of a rim of a steering wheel according to an exemplary embodiment.

FIG. 14B is a schematic exploded cross-section view of a composite structure of a rim of a steering wheel according to an exemplary embodiment.

FIG. 14C is a schematic exploded partial cross-section view of a composite structure of a rim of a steering wheel according to an exemplary embodiment.

FIG. 14D is a schematic cross-section view of a composite structure of a rim of a steering wheel according to an exemplary embodiment.

FIG. 15A is a schematic exploded perspective view of a composite structure of a rim of a steering wheel according to an exemplary embodiment.

FIG. 15B is a schematic exploded cross-section view of a composite structure of a rim of a steering wheel according to an exemplary embodiment.

FIG. 15C is a schematic exploded partial cross-section view of a composite structure of a rim of a steering wheel according to an exemplary embodiment.

FIG. 15D is a schematic cross-section view of a composite structure of a rim of a steering wheel according to an exemplary embodiment.

FIGS. 16A through 16F are schematic partial perspective views of a composite structure of a rim of a steering wheel according to an exemplary embodiment.

FIG. 17 is a schematic exploded view of a steering wheel with a functional module and control module according to an exemplary embodiment.

FIG. 18 is a schematic exploded view of a steering wheel with a functional module and control module according to an exemplary embodiment.

FIG. 19A is a schematic exploded perspective view of a composite structure of a rim of a steering wheel according to an exemplary embodiment.

FIG. 19B is a schematic exploded cross-section view of a composite structure of a rim of a steering wheel according to an exemplary embodiment.

FIG. 19C is a schematic exploded partial cross-section view of a composite structure of a rim of a steering wheel according to an exemplary embodiment.

FIG. 19D is a schematic cross-section view of a composite structure of a rim of a steering wheel according to an exemplary embodiment.

FIGS. 20A through 20E are schematic partial perspective views of a composite structure of a rim of a steering wheel according to an exemplary embodiment.

FIGS. 21A through 21E are schematic flow diagrams of a method for forming a composite structure into a rim for a steering wheel according to an exemplary embodiment.

### DESCRIPTION

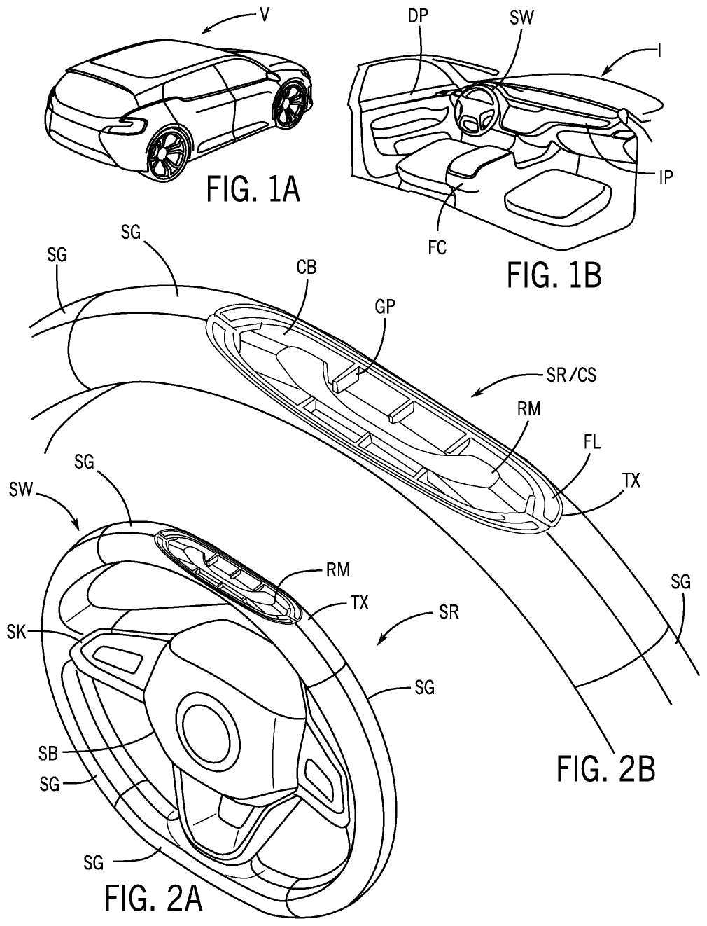

Referring to FIGS. 1A-1B, a vehicle V is shown with an interior I comprising components including trim panels such as instrument panel IP and a door panel DP and a console shown as floor console FC and a steering wheel SW.

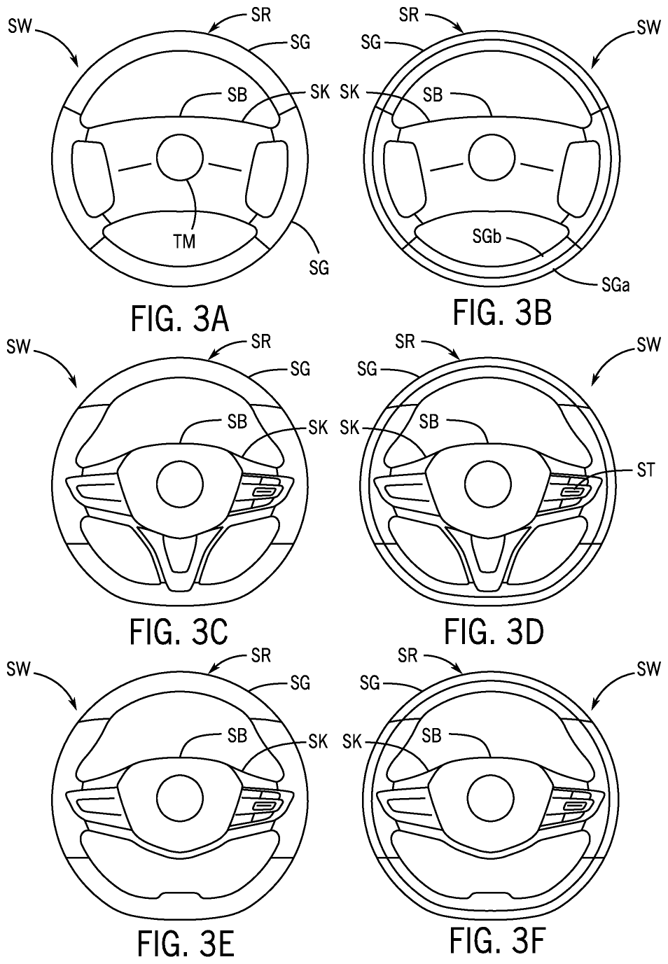

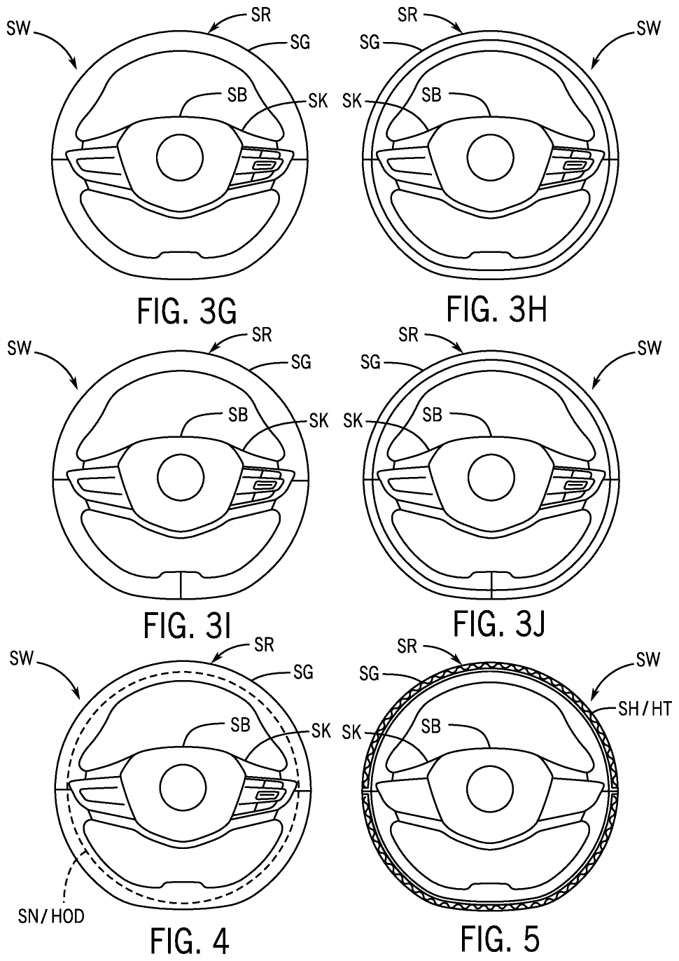

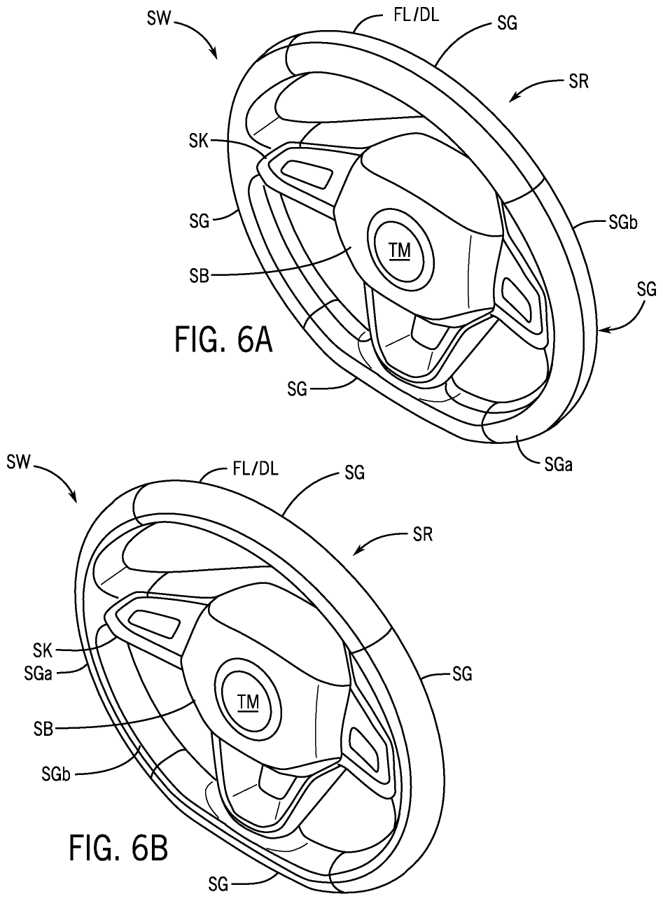

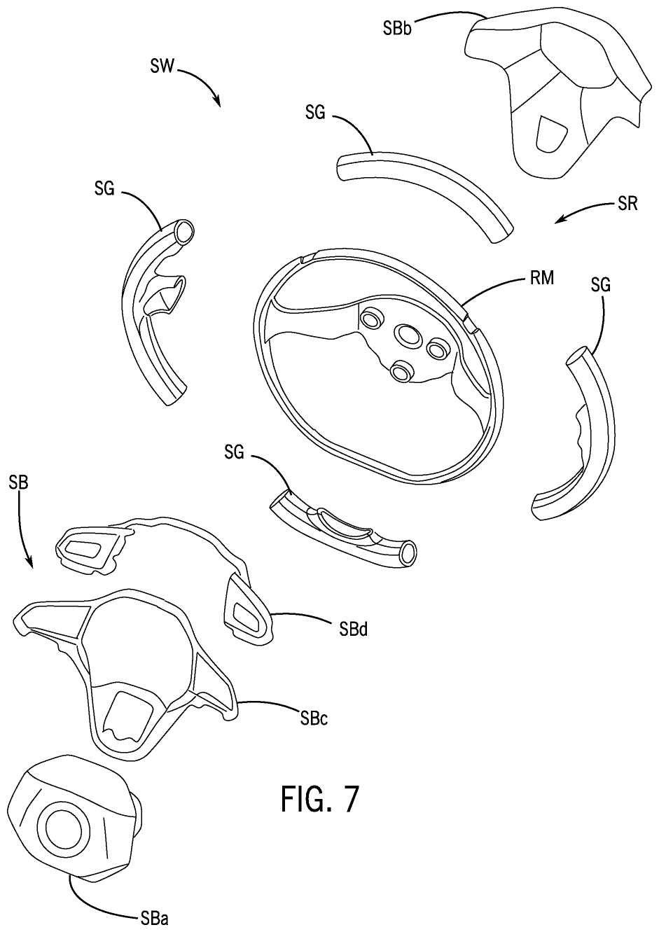

According to an exemplary embodiment as shown schematically in FIGS. 2A-2B and 6A-6B, the steering wheel SW may comprise a base section SB (with an emblem/logo TM) and a spoke structure SK with a rim SR; rim SR may comprise a composite structure CS assembled on a frame RM; rim SR/CS may comprise a set of segments SG (shown as shell segments SGa and SGb); segments SG may comprise a cover TX providing an exterior/cover layer (shown as functional layer and/or decorative layer FL/DL) and a positioning element GP on a base/carrier CB. See also FIGS. 3A-3J, 4 and 5.

As indicated schematically in FIGS. 3A-3J and 6A-6B, steering wheel SW may be provided in any of a wide variety of configurations of base SB and/or spokes SK and/or rim SR with segments SG; as indicated schematically, rim SR may comprise any of a wide variety of configurations of segments SG; segments SG may be provided in any of a wide variety of configurations. As indicated schematically in FIGS. 3A, 3C, 3E, 3G and 31, 6B, rim SR may comprise segments SG in an axially-arranged orientation (e.g. adjacent segments/sections); as indicated schematically in FIGS. 3B, 3D, 3F, 3H, 3J and 6A, rim SR may comprise segments with sections in a radial arrangement (e.g. segment shell sections SGa and SGb configured to be assembled onto the frame of the rim SR).

According to an exemplary embodiment as shown schematically in FIGS. 2A-2B, 4 and 5, steering wheel SW may comprise a rim SR providing a functional segment comprising a sensor for hands-off detection SN/HOD and/or a heating section or element SH/HT. As indicated schematically in FIG. 3D, steering wheel SW may comprise a switch ST for interaction with a vehicle system.

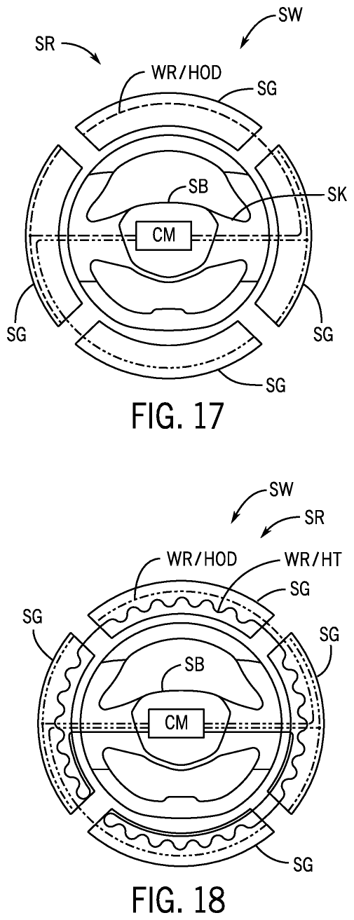

According to an exemplary embodiment as shown schematically in FIGS. 17 and 18, steering wheel SW may comprise a rim SR providing a functional segment comprising a functional module for hand-off detecting HOD and/or heating HS/HT. As indicated schematically in FIGS. 17 and 18, steering wheel SW may comprise a controller/control module CM shown as installed within base SB.

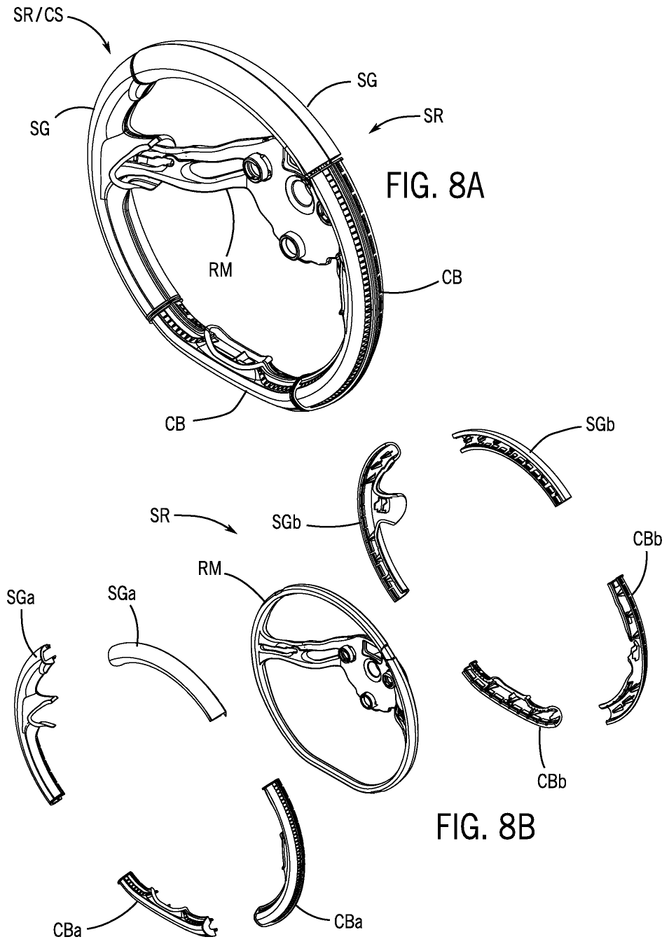

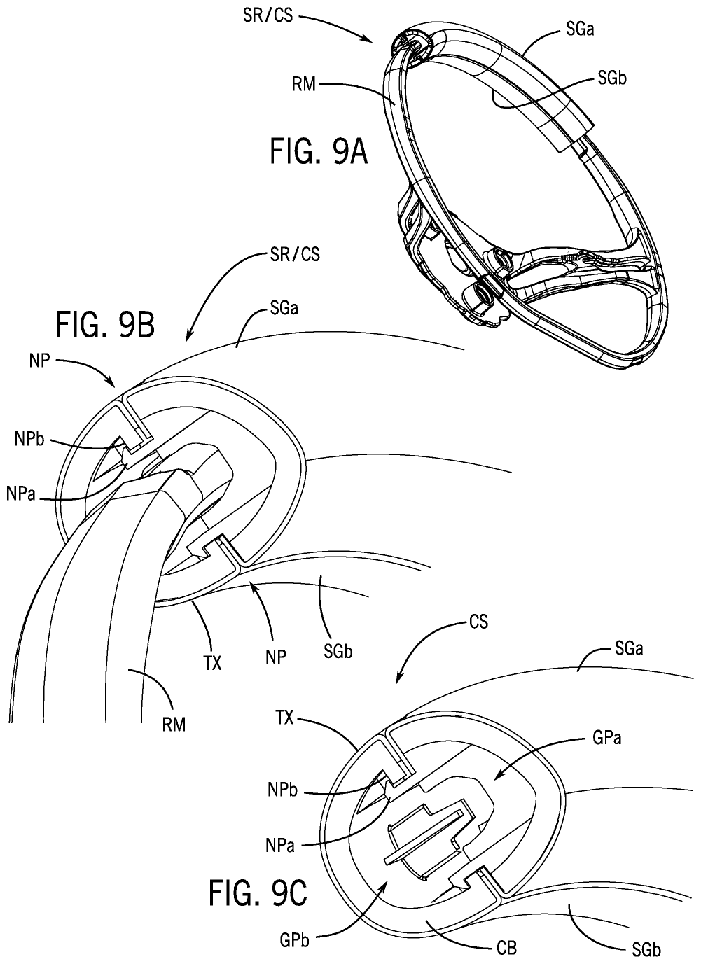

As indicated schematically according to an exemplary embodiment in FIGS. 6A-6B, 7 and 8A-8B, the base SB of the steering wheel SW may comprise a base cover SBa and a rear housing SBb with a frame SBc and frame SBc to be assembled onto a frame structure shown as armature RM; the composite structure CS of rim SR of the steering wheel on the frame structure shown as armature RM may comprise segments SG that may comprise segment sections shown a shell sections SGa and SGb with a carrier CB that may comprise sections CBa and CBb. See also FIG. 9A.

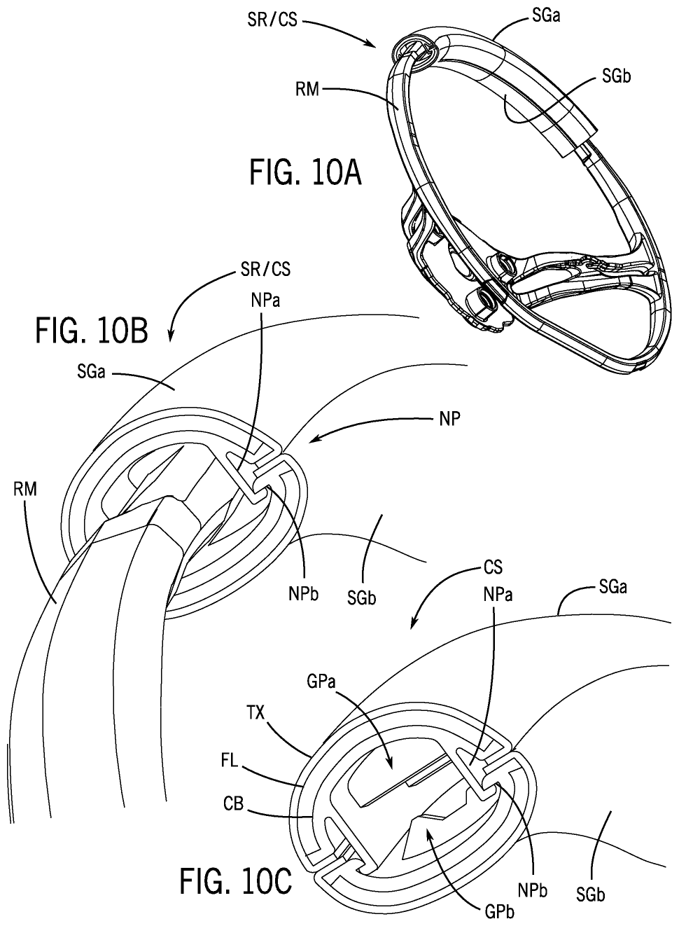

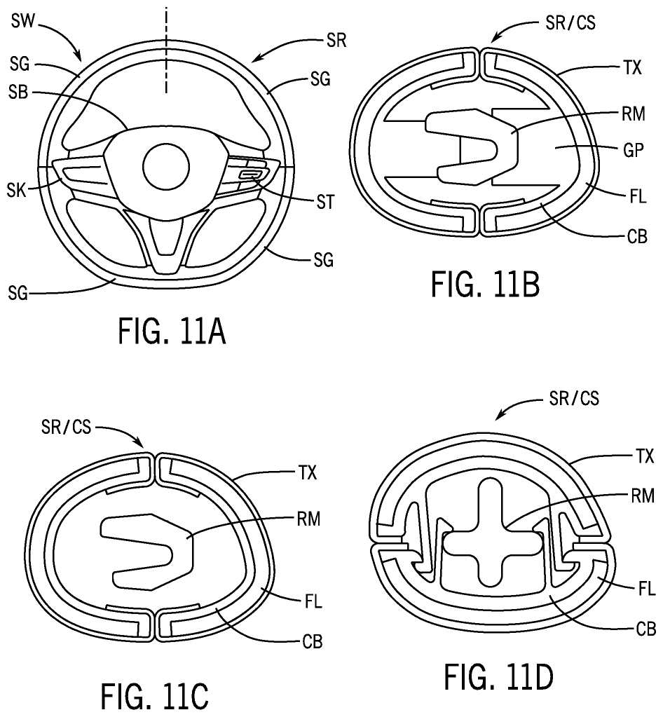

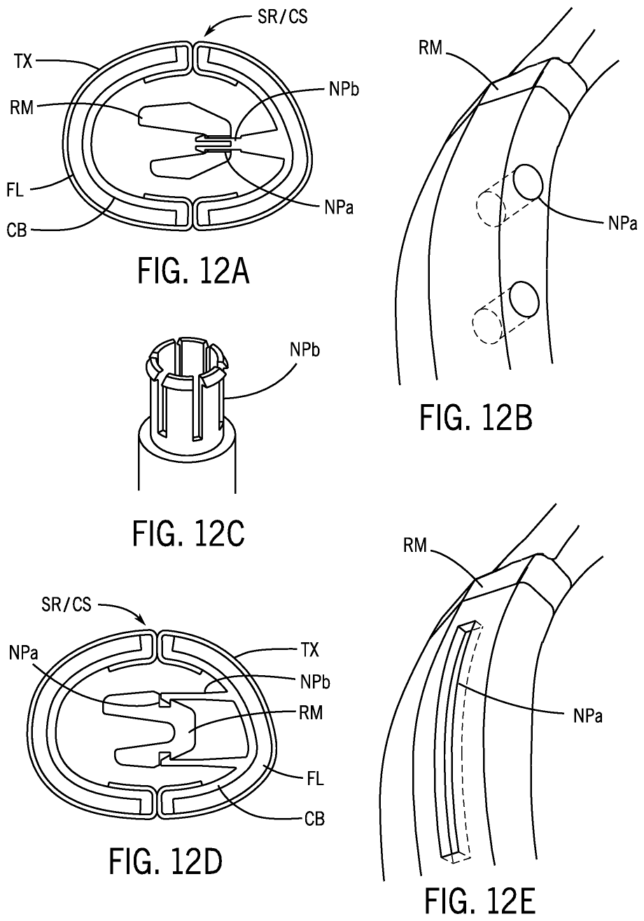

As indicated schematically according to an exemplary embodiment in FIGS. 9A-9C, 10A-10C, 11A-11D and 12A-12E, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may comprise a positioning/alignment section comprising element GPa and element GPb and a carrier/base layer CB with a cover comprising a cover layer TX. As indicated schematically in FIGS. 9B-9C, 10B-10C and 11D, engagement element NPa may be provided within the composite structure CS; as indicated schematically in FIGS. 12A-12B and 12D-12E, engagement element NPa may be provided on the frame structure RM. See also FIG. 12C (axially-oriented engagement element NPb).

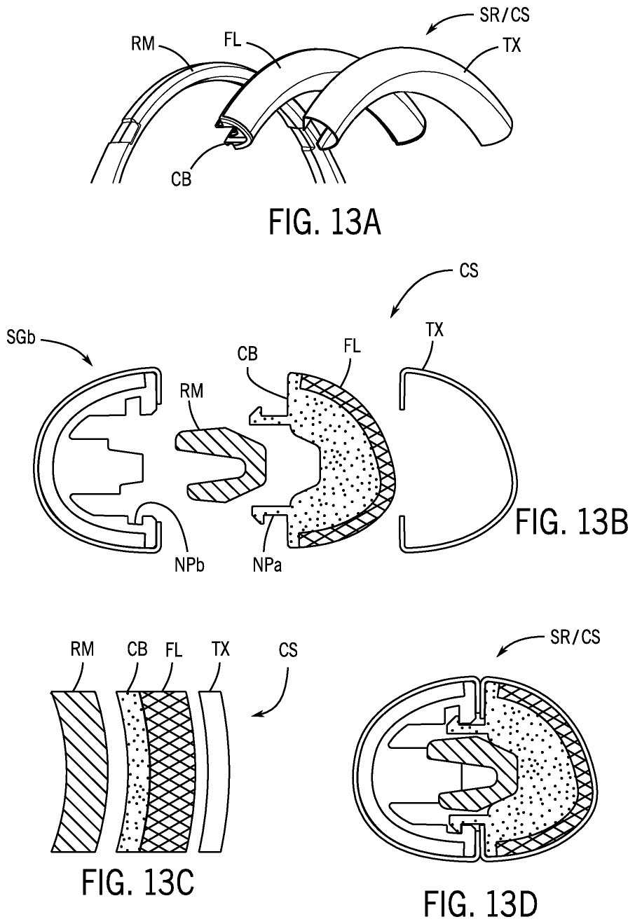

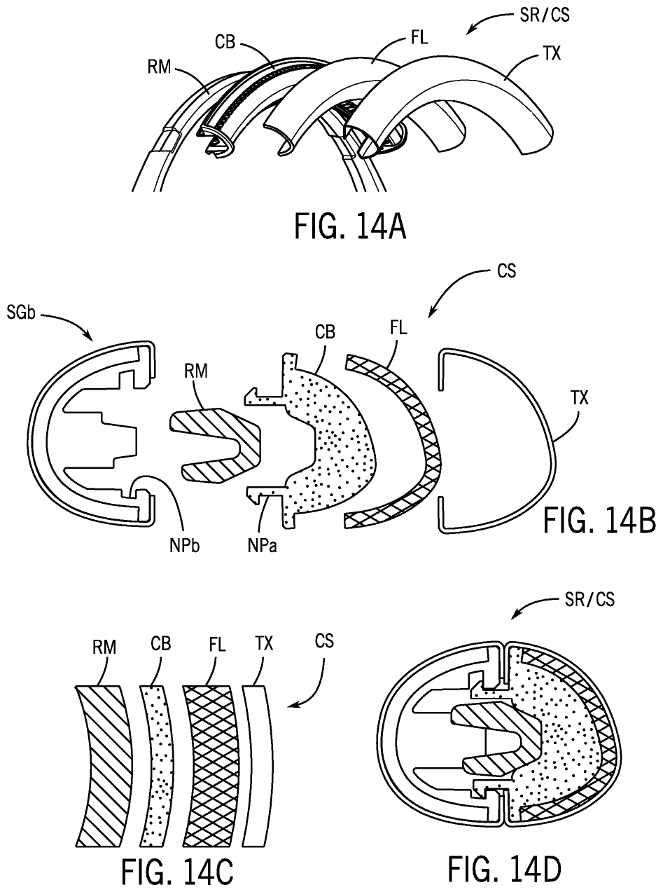

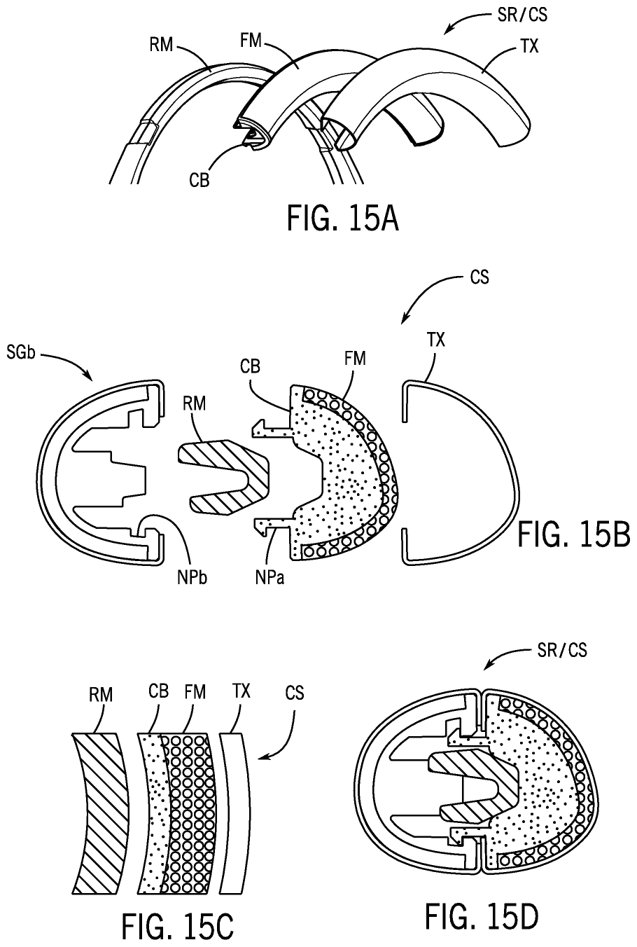

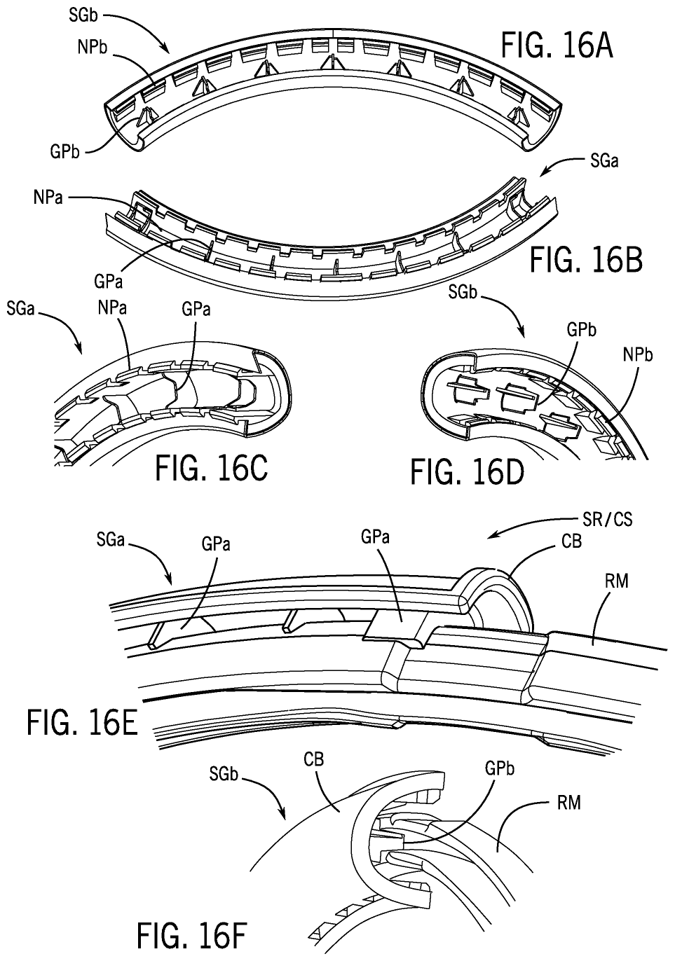

As indicated schematically according to an exemplary embodiment in FIGS. 13A-13D, 14A-14D and 15A-15D, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may also comprise a functional layer FL shown as a spacer material and a carrier/base layer CB with a cover comprising a cover layer TX. As indicated schematically, engagement element NPa and engagement element NPb may be provided within the composite structure CS (e.g. as a projection and retainer/recess for a fitting connection, such as a snap-fit connection).

As indicated schematically according to an exemplary embodiment in FIGS. 16A-16F, the composite structure CS for rim SR on frame RM may comprise segment SGa and segment SGb configured for engagement at an engagement portion NP shown as comprising engagement element NPa and engagement element NPb which engage to retain segment/sections SGa and SGb onto frame structure RM; segments SG may comprise a positioning/alignment section comprising element GPa and element GPb (e.g. plurality of elements arranged for the segment/shell section) and a carrier/base layer CB with a cover comprising a cover layer TX. As indicated schematically, positioning element GPa and positioning element GPb may be provided within the composite structure CS to facilitate the placement/location of the segment/shell sections SGa and SGb during assembly onto frame structure RM; as indicated schematically, the positioning/alignment elements may provide structure for the segment and space/pathway for items such as connectors, wires, cables, lighting, sensors, etc. to be installed within the rim and/or between segments of the rim (e.g. such as for connectivity with functional segments, functional modules, functional layers, etc. to controller/control system, vehicle systems, etc.).

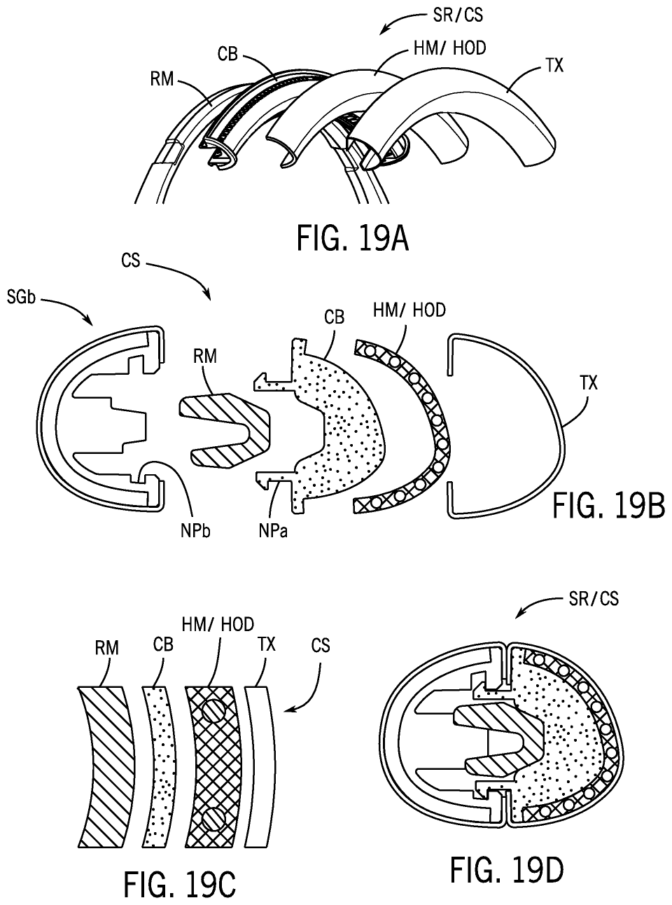

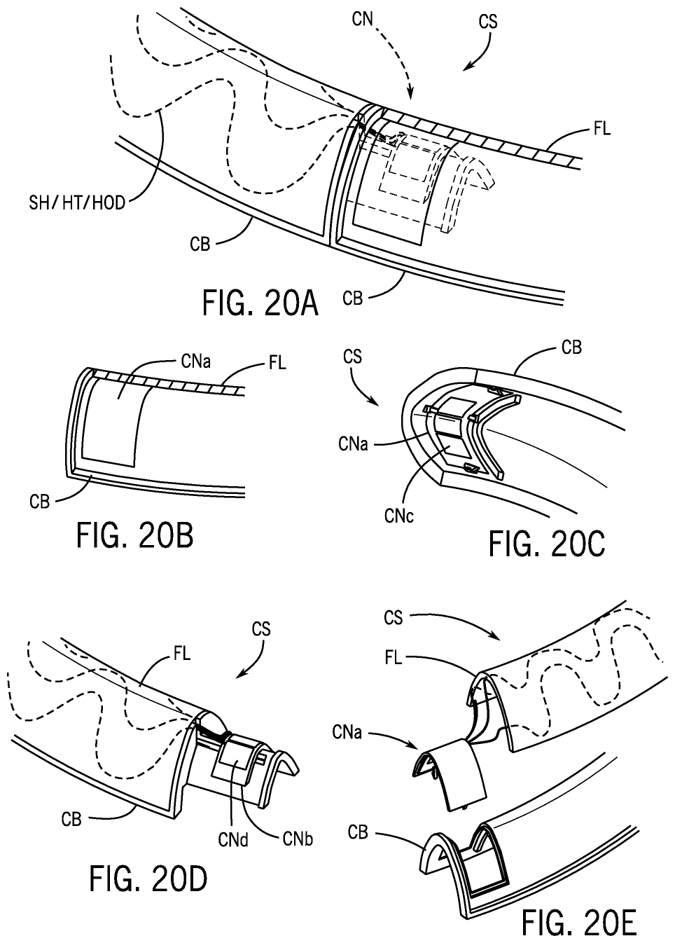

As indicated schematically in FIGS. 17, 18 and 19A-19D, the steering wheel SW may comprise a controller/control module CM in the base SB with a rim SR comprising segments shown as functional segments SG (e.g. segments with functional layer/module) such as a hands-off sensor WR/HOD (see FIG. 17A) or an integrated arrangement of hands-off sensor WR/HOD with heating element WR/HT (see FIGS. 17B and 19A-19D) or a transducer SC or sensor SN or lighting elements SN or heating element/wire SH (see FIG. 18A) or lighting elements shown as light source/LED light LS/LED (see FIG. 18B). As indicated schematically in FIGS. 20A-20E, composite structure CS for segments of the rim such as functional segments comprising a carrier CB and functional layer FL comprising the integrated hands-off sensor HOD and heating element SH/HT (e.g. mat with heating wire arrangement) may be connected by a connector CN comprising a connector elements CNa and CNb and CNc and CNd positioned for electrical connectivity within the segment/rim.

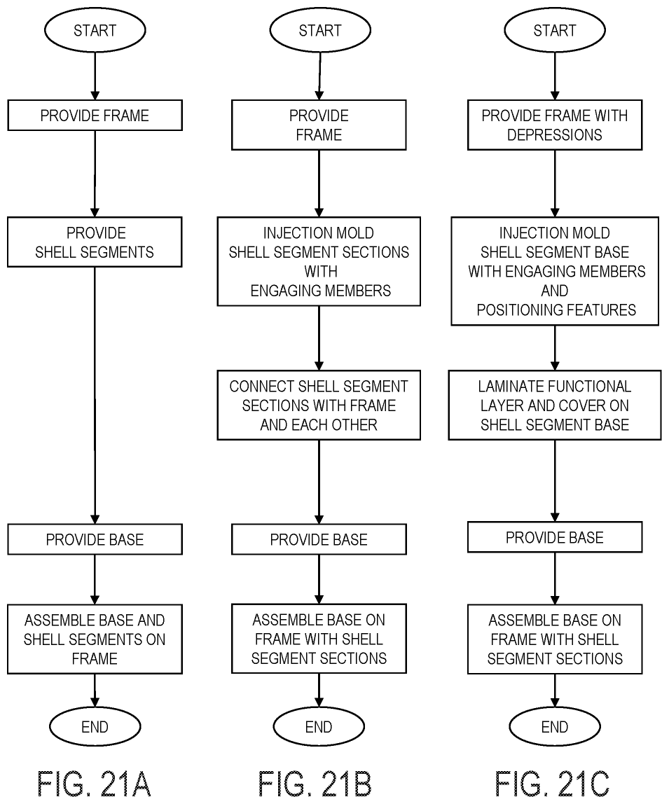

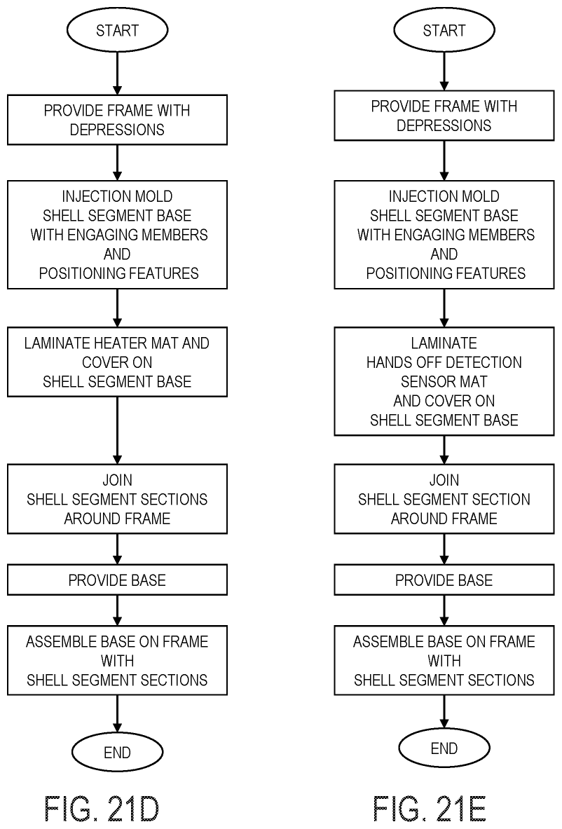

A method for forming the composite structure is shown schematically according to an exemplary embodiment in FIGS. 21A-21E.

### Exemplary Embodiments—A

According to an exemplary embodiment as shown schematically in FIGS. 2A-2B, 3A-3J, 4, 5, 6A-6B, 7 and 8A-8B, a steering wheel of a type providing a base and a frame may comprise a rim comprising a composite structure connected to the base. The composite structure of the rim may comprise at least one shell segment comprising a cover layer and an intermediate layer under the cover layer. The cover layer may comprise an exterior surface for the rim. The intermediate layer may comprise at least one of a soft material or a resilient material. The intermediate layer may comprise at least one of a foam material or a spacer material. The intermediate layer may comprise a carrier layer on the frame. The intermediate layer may comprise a carrier layer on the frame and at least one of soft material or a resilient material or a foam material or a spacer material. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The rim may comprise a multi-segment construction comprising a set of selectable shell segments. The set of shell segments may comprise a first segment and a second segment; the cover layer on the first segment may be different than the cover layer on the second segment. The set of shell segments may comprise a first segment and a second segment; the first segment may be different than the second segment. Each segment of the set of shell segments may comprise a shell segment base. Each shell segment of the set of shell segments may comprise an engagement portion. When the set of shell segments is assembled onto the frame the engagement portion of a first shell segment may be connected at the engagement portion of a second shell segment. When the set of shell segments is assembled onto the frame the engagement portion of a first shell segment may be snap-fit connected at the engagement portion of a second shell segment. When the set of shell segments is assembled onto the frame the engagement portion of a first shell segment may be connected at the engagement portion of a second shell segment in axial alignment. The engagement portion may comprise a connector and/or a plurality of connectors. The connector may comprise a snap-fit connector. The connector may comprise a snap-fit connector comprising a projection and a receptacle for the projection. The engagement portion may comprise at least one of a projection or a receptacle for the projection. The at least one shell segment may comprise a first shell section and a second shell section. When the set of shell segments is assembled onto the frame the first shell section may be attached to the second shell section. When the set of shell segments is assembled onto the frame the first shell section may be attached to the second shell section in radial alignment. The at least one shell segment may comprise a first shell section and a second shell section. The first shell section may comprise a first engagement portion; the second shell section may comprise a second engagement portion configured to engage the first engagement portion of the first shell section. The cover layer may comprise a decorative layer. The composite structure may comprise a positioning element. The at least one shell segment may comprise a positioning element. The cover layer may be configured to provide a visual effect for the rim and/or a tactile effect for the rim. The cover layer may comprise at least one of a fabric material, a textile material, a fiber material, a leather, a synthetic leather material, a foil, a skin, a wrap, a veneer, a recycled material. The composite structure may be configured to provide a visual effect for the rim. The visual effect may comprise a multi-segment appearance. The visual effect may comprise a multi-section appearance. The visual effect may comprise a multi-tone appearance. The visual effect may comprise a modular appearance. The at least one segment may comprise a first segment and a second segment; the cover layer of the first segment may be different from the cover layer of the second segment. The steering wheel may comprise a spoke structure connecting the rim to the base. The steering wheel may comprise a functional layer; the functional layer may comprise at least one of a (a) sensor for hands-off detection or (b) heating mat. The base may comprise an airbag module. The frame may comprise an armature. The base may comprise a cover; the cover may provide a logo.

According to an exemplary embodiment as shown schematically in FIGS. 2A-2B, 3A-3J, 4, 5, 6A-6B, 7 and 8A-8B, a steering wheel of a type providing a base and a frame may comprise a rim comprising a composite structure connected to the base. The composite structure of the rim may comprise at least one shell segment comprising a cover layer and an intermediate layer under the cover layer. The composite structure may be configured to provide a visual effect for the rim. The at least one shell segment may comprise a set of shell segments. The visual effect may comprise a multi-segment appearance provided by the set of shell segments. The visual effect may comprise a multi-segment appearance. The visual effect may comprise a multi-section appearance. The visual effect may comprise a multi-tone appearance. The cover layer may be configured to provide the visual effect for the rim. The cover layer may comprise at least one of a fabric material, a textile material, a fiber material, a leather, a synthetic leather material, a foil, a skin, a wrap, a veneer, a recycled material. The intermediate layer may comprise at least one of a foam material or a spacer material. The intermediate layer may comprise a carrier layer on the frame. The at least one shell segment may comprise an engagement portion. The at least one shell segment may comprise a set of shell segments. The set of shell segments may comprise a set of selectable shell segments configured to be assembled onto the frame of the rim. The rim may comprise a multi-segment construction comprising the set of shell segments. The set of shell segments may comprise a first segment and a second segment; the cover layer on the first segment may be different than the cover layer on the second segment. The set of shell segments may comprise a first segment and a second segment; the first segment may be different than the second segment. The set of shell segments may be assembled onto the frame in axial alignment. The set of shell segments may be assembled onto the frame in axial alignment at an engagement portion. The engagement portion may comprise a connector for each shell segment of the set of shell segments. The connector may comprise a snap-fit connector comprising a projection and a receptacle for the projection. The at least one shell segment may comprise a first shell section and a second shell section. The set of shell segments may be assembled onto the frame; the first shell section may be attached to the second shell section in radial alignment. The first shell section may comprise a first engagement portion; the second shell section may comprise a second engagement portion configured to engage the first engagement portion of the first shell section.

According to an exemplary embodiment as shown schematically in FIGS. 2A-2B, 3A-3J, 4, 5, 6A-6B, 7, 8A-8B, 17, 18, 19A-19D and 20A-20E, a steering wheel of a type providing a base and a frame may comprise a rim comprising a composite structure connected to the base. The composite structure of the rim may comprise at least one shell segment comprising a cover layer and an intermediate layer under the cover layer. The composite structure may comprise a functional layer. The functional layer may comprise at least one of (a) a hands-off sensor or (b) a heating element. The at least one shell segment may be configured for integration of the functional layer. The at least one shell segment may be configured for interconnection of the functional layer. The composite structure may comprise a connector for the functional layer. The base may comprise a control module for the functional layer. The composite structure may comprise a positioning element. The at least one shell segment may comprise a positioning element. The positioning element may be configured to facilitate connectivity for the functional layer. The base may comprise an airbag module. The frame may comprise an armature. The base may comprise a horn module.

### Exemplary Embodiments—B

As indicated schematically in FIGS. 2A-2B, 3A-3J, 4, 5, 6A-6B, 7 and 8A-8B, the composite structure of the rim of the steering wheel may comprise segments such as shell segments configured to facilitate variable/various, customizable, light weight construction for decoration and that can be produced efficiently and/or connected and replaced and selected for arrangement; connection between segments may comprise mechanical connections such as clips, ribs, protrusions (and counterparts); connection of segments and the form of the composite structure can be configured to facilitate positioning and alignment as well as to enhance/control spacing/distance, ensure robust connection (e.g. reduce squeak, rattle, etc.) and to provide space for available to be used for electronic components (e.g, wires, sensors, plug in connectivity, etc.) and/or other materials and items within the rim.

As indicated schematically in FIGS. 2A-2B, 3A-3J, 4, 5, 6A-6B, 7 and 8A-8B, the composite structure of the rim of the steering wheel may comprise segments such as shell segments provides a design configuration that facilitates interchangeable variations of segments and/or decorative/cover materials with visual effect, tactile effect, durability, functional capability; internal construction configuration facilitates integration of different individual or multiple functions as well as a lower mass/lighter weight form that is intended to be more efficient to produce (e.g. no stitching, no-stitch appearance, reduced size/mass, simpler mechanical connections, fewer total parts, etc.); the configuration of the composite structure and/or segments are intended to facilitate replacement and/or updating over the vehicle life time (e.g. including available interchange/exchange such as using new parts, spare parts for update/replacement, etc.).

As indicated schematically in FIGS. 2A-2B, 3A-3J, 4, 5, 6A-6B, 7 and 8A-8B, the composite structure of the rim of the steering wheel may comprise segments such as shell segments configured as segmented sections with fitting parts; the composite structure of the rim facilitates efficient assembly and construction to allow the overall intended decorative effect and tactile effect/durability (e.g. material selection for appearance, visual effect, tactile effect, durability, customization, sustainability, light weight, etc.). Construction of the composite structure is intended to facilitate effects for enhanced performance and manufacturability; fitment of elements of the composite structure and/or connection of segments/sections can be enhanced to facilitate use of space within the rim for optimized performance (e.g. space creation, air gap, light weight, package space).

According to an exemplary embodiment, a vehicle interior component and a method for manufacturing said vehicle interior component is shown schematically in FIGS. 2A-2B, 3A-3J, 4, 5, 6A-6B, 7, 8A-8B and 21A-21E; the component may comprise a trim component comprising a cover and a substrate/carrier in a composite structure assembled on a frame for the rim of a steering wheel. The cover may comprise an exterior cover layer, an intermediate cover layer, a functional layer and a base. The substrate may comprise a depression, a projection and/or a fastening portion. The substrate may comprise a metal and a soft material. The cover/base may comprise a depression, a projection and/or a fastening portion. The depression and/or projection are configured to align substrate and cover. The cover may comprise cover segments. The cover segments may be configured to present the cover. The functional layer may comprise a heating mat, a sensor, a light-transmissive layer. The method of forming/assembling the component may comprise (a) at least one of a foaming process, an injection molding process or a press lamination process; (b) positioning of the cover or of the cover segments on the substrate; (c) fixing of the cover or of the cover segments to the substrate; (d) surrounding of the substrate with cover segments; (e) joining of the cover segments with each other around the substrate.

According to an exemplary embodiment, the rim and composite structure may comprise selected materials for cost/performance; the frame structure/armature may comprise a metal, metal alloy (e.g. magnesium, aluminum, steel, etc.); the shell segments and other plastic elements such as the carrier, etc. may comprise a plastic, molded plastic (e.g. polypropylene, nylon plastic, polyamide nylon, polystyrene, acetal plastic, polyoxymethylene, polycarbonate, acrylonitrile butadiene styrene, polyethylene terephthalate, or other plastic compounds); the heating mat and/or sensor layer may comprise a commercially-available structure or an integrated/formed structure with heating wires (e.g. within a matrix/substrate, foam, elastomer, filled foam, graphene-filled foam, etc.); connections and connectors for electric/electronic system may be commercially-available structures or produced from suitable materials (e.g. as for heating mat/wires, sensor mat, etc.).

According to an exemplary embodiment as indicated schematically in FIGS. 2A-2B, 3A-3J, 4, 5, 6A-6B, 7 and 8A-8B, a component for an interior of a vehicle may comprise a rim configured to be assembled on a steering wheel comprising a frame; the rim may comprise a composite structure; the composite structure may comprise a set of segments to be assembled on the frame; the composite structure may comprise a cover and a carrier; a segment of the set of segments may comprise at least one of a decorative segment and/or a functional segment. The composite structure may comprise a positioning layer. The segment may comprise a manufactured segment and/or replaceable segment and/or an exchangeable segment and/or spare part segment. The segment may be configured to provide a cavity between the frame and the segment; the cavity may be configured to accommodate cables, wires, etc. The segment of the composite structure may comprise a manufactured element and/or an exchangeable element and/or a replaceable element and/or a selectable element and/or a spare part segment.

REFERENCE SYMBOL LIST

| ELEMENT, PART OR COMPONENT | REFERENCE SYMBOL |
|---|---|
| Vehicle | V |
| Interior | I |
| Door Panel | DP |
| Floor Console | FC |
| Instrument Panel | IP |
| Steering Wheel | SW |
| Composite Structure | CS |
| Armature/Frame | RM |
| Base | SB, SBa, SBb, SBc, SBd |
| Spoke | SK |
| Rim | SR |
| Switch | ST |
| Controller/Control Module | CM |
| Connector | CN, CNa, CNb, CNc, CNd |
| Wire | WR |
| Shell Segment/Section | SG, SGa, SGb |
| Shell Segment Base | CB |
| Positioning Feature | GP, GPa, GPb |
| Engagement Member (Fastening Member) | NP, NPa, NPb |
| Heater | SH |
| Sensor | SN |
| Functional Layer | FL |
| Hands-Off Detection Sensor Mat | HOD |
| Heating Mat | HT |
| Decorative Layer | DL |
| Cover | TX |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising a steering wheel comprising:
a frame;
a composite structure comprising a set of segments;
wherein the set of segments comprises a set of shell segments configured to be assembled in axial alignment on the frame.

2. The component of claim 1 wherein the set of shell segments comprises a set of shell sections configured to be fit in radial engagement around the frame.

3. The component of claim 2 wherein the set of shell sections comprises a shell section configured to be fit onto the frame.

4. The component of claim 2 wherein the frame comprises a feature configured to facilitate axial alignment of a shell section of the set of shell sections on the frame.

5. The component of claim 2 wherein the frame comprises a feature configured to facilitate radial engagement of a shell section of the set of shell sections on the frame.

6. The component of claim 5 wherein the feature of the frame comprises an indentation.

7. The component of claim 2 wherein the set of shell sections comprises a front section and a back section.

8. The component of claim 2 wherein the set of shell sections comprises a first section configured to be fit onto the frame and a second section configured to be fit with the first section.

9. The component of claim 2 wherein the set of shell sections comprises a first section comprising an engagement portion configured to be fit with the frame and a second section comprising an engagement portion configured to be fit with the first section.

10. The component of claim 2 wherein the set of shell sections comprises a first section comprising an engagement portion configured to be fit with the frame and a second section comprising an engagement portion configured to be snap-fit with the first section.

11. The component of claim 2 wherein the set of segments comprises at least one of a decorative segment and/or a functional segment.

12. The component of claim 1 wherein the steering wheel comprises a rim;
wherein the rim comprises a cover configured to provide an exterior surface and an intermediate layer under the cover; wherein the intermediate layer comprises at least one of a shell section and/or a soft material and/or a resilient material.

13. A steering wheel providing a frame comprising:
a composite structure;
wherein the composite structure comprises a set of segments configured to be assembled onto the frame;
wherein the set of segments comprises at least one shell segment configured for radial engagement and axial alignment on the frame;
wherein the at least one shell segment comprises a set of shell segments;
wherein the composite structure is configured to provide a visual effect.

14. The steering wheel of claim 13 wherein when the set of shell segments is assembled onto the frame an engagement portion of a first shell segment can be connected at an engagement portion of a second shell segment.

15. The steering wheel of claim 13 wherein when the set of shell segments is assembled onto the frame an engagement portion of a shell segment can be connected at a feature of the frame.

16. The steering wheel of claim 15 wherein the feature of the frame comprises an indentation on the frame configured to facilitate axial alignment of a shell segment.

17. The steering wheel of claim 13 wherein the set of shell segments comprises a set of shell sections configured to fit together in radial engagement.

18. The steering wheel of claim 13 wherein the set of shell segments comprises a first segment and a second segment; wherein the first segment is different than the second segment.

19. The steering wheel of claim 13 wherein the at least one shell segment comprises a positioning element.

20. The steering wheel of claim 13 wherein the composite structure comprises a cover comprising a cover layer; wherein the cover layer comprises a decorative layer and/or a functional layer; wherein the cover layer is configured to provide a visual effect and/or a tactile effect.

21. The steering wheel of claim 13 wherein the at least one shell segment comprises a set of shell segments configured to provide the visual effect; wherein the visual effect comprises a multi-segment appearance.
